(19) United States
(12) Patent Application Publication
(10) Pub. No.: US 2004/0221822 A1
(43) Pub. Date: Nov. 11, 2004

(54) Device for increasing the power of internal combustion engines

(76) Inventor: Jack Silver, Upland, CA (US)

Correspondence Address: Jack Silver, 404 E. Merrimac St., Upland, CA, 91784, US

(21) Appl. No.: 10/703,364

(22) Filed: Nov. 10, 2003

Related U.S. Application Data
(63) Continuation of application No. 10/016,218, filed on Oct. 29, 2001, now Pat. No. 6,463,917.

(51) Int. Cl. F02B 23/00; F02B 41/00

(52) U.S. Cl. 123/26; 123/585

(57) ABSTRACT

This invention is an improvement of U.S. Pat. No. 6,463,917 that produces an increased and continuous volume of Ozone and Nitrous Oxide that is self controlling, provides increased power and a 33% increase in fuel mileage while preventing the formation of noxious nitrogen oxides.

### CROSS-REFERENCE TO RELATED APPLICATIONS

Not Applicable

### STATEMENT REGARDING FEDERALLY SPONSORED RESEARCH AND DEVELOPMENT

Not Applicable

REFERENCE TO SEQUENCE LISTING, A TABLE OR COMPUTER PROGRAM LISTING COMPACT DISC APPENDIX

Not Applicable

### BACKGROUND OF THE INVENTION

0001. This invention relates to improving the performance of U.S. Pat. No. 6,463,917. Further research into chemical activity involved, and certain mechanical construction, dictates important improvements to said invention.

0002. Originally, in the said invention, due to the graphic results of a dynamometer test, which indicated very low emission of Nitrogen Oxides, it was decided that the Ozone simply displaced the nitrogen and that nitrogen molecules were eliminated. On the contrary, nitrogen plays a very important part in the production of power and the elimination of the worst pollutants.

0003. Accordingly, the objects of the improvements are control of high voltage, its improved rapid response, high energy pulses that interrupt and increase the flow of current to the primary winding of the coil so as to more rapidly induce the high voltage in the secondary winding. Also to expand on the formation and injection of Nitrous Oxide (N₂O) produced.

0004. Research into the chemistry involved in the production of commercial Ozone has led to a number of pertinent conclusions. Ozone is formed, primarily, in two ways. There is the action of the sun's powerful electro-magnetic rays forming Ultra-Violet rays that strike the Oxygen molecules (O₂) and split them into two atoms, O and O having, single unpaired valence bonds. Those atoms, when they exist alone, however briefly, are highly reactive radicals, instantaneously attracted to other molecules of Oxygen to form Ozone (O₃). The splitting of O₂ is also done by high voltage lightning flashing through the atmosphere, high voltage and low voltage arcing by transformers, electric motors, generators and amusement park bumper cars with their trolleys scraping the electrically charged ceiling.

0005. Much of the powerful UV rays do reach the surface of the earth, causing sunburn, eye and plant and animal damage, while forming vast amounts of atmospheric Ozone that is found everywhere, including the large quantities found in Los Angeles, where blame for high Ozone levels are placed on motor vehicles. It is true that internal combustion engines form Ozone, however they also form Nitric Oxide (NO) and Nitrogen Dioxide (NO₂). NO destroys Ozone on contact. Scientists are worried that high flying aircraft are damaging our Ozone layer with the Nitric Oxide released. Nitrogen Dioxide forms the brown, poisonous smog layer over Los Angeles that absorbs air moisture to become Nitric Acid.

0006. Ozone is unstable at room temperatures. It does not exist long enough to do harm. In an enclosed room with a high concentration, it would be poisonous, but so would a high concentration of Carbon Dioxide (CO₂).

0007. A second important reaction takes place within the portion of the air intake tube that is sandwiched by the high voltage electrodes. Those same hyperactive single Oxygen atoms, contact Nitrogen molecules (N₂), instantly forming Nitrous Oxide (N₂O), commonly known as “Nitrous”. It is this formation of Nitrous, absorbing the Nitrogen and preventing the formation of other-oxides that resulted in the low incidence of NOₓ in the Diagnostic Test herein.

0008. In the prior art, ultra violet sources and various voltages were used to generate Ozone. None have proven to be practicable due to a low volume of Ozone generated, impedance of air flow by placement of the various parts, extreme complexity, difficulty and high cost of manufacture. Only negative thought was given to the small quantity of Nitrous Oxide that was formed and even proposing the use of pure Oxygen instead of air to prevent its formation.

0009. An improvement found in the present invention is the use of high capacity electrolytic capacitors attached to the wire that powers the high voltage coil. As the capacitors are rapidly charged and discharged with increased voltage, they make and break the current to the primary winding of the coil that induces the high voltage in the secondary needed.

0010. An improvement is the addition of a supplementary section of tubing, sandwiched by high voltage electrodes and connected to the existing intake tube, where said intake tube is inaccessible and without a clear section to attach the electrodes. The rapidity of reactions taking place between said electrodes results in a constant and continuous, self-controlling flow of Ozone and Nitrous as long as the engine is operating.

0011. When gasoline is consumed in an internal combustion engine with said patent and improvements attached to the air intake tube, the result is; Gasoline plus Ozone yields Carbon Dioxide, Water and Oxygen. O₁ and N₂O are consumed.

0012. Referring to the Diagnostic Test results included herein, the pollutants, which U.S. Pat. No. 6,463,917 and the present improvement invention does control are; Unburned hydrocarbons (HC) that form eye and lung irritating Aldehydes and Ketones; Carbon Monoxide (CO) a very poisonous gas; Nitrogen Oxides (NOₓ), such as Nitrogen Dioxide (NO₂), a corrosive gas that forms the BROWN LAYER of SMOG seen in large heavily trafficked cities, for example Los Angeles, New York, Chicago and others, which upon contact with moisture in the air, forms highly corrosive Nitric Acid (HNO₃) that attacks eyes, lungs, plants and metals.

0013. The Diagnostic Test performed on the test engine, shows that after the initial 20 seconds of operation and a speed of 25 miles per hour, Unburned Hydrocarbons (HC) was ZERO; Nitrogen Oxides (NO) was almost ZERO; Carbon Monoxide (CO) was ZERO; Oxygen (O₂), including Ozone (O₃) was ZERO (all consumed); and Carbon Dioxide (CO₂) 15.1% the same gas we exhale after every breath.

0014. It is clear that no Oxygenates need be added to Gasoline, such as, poisonous Methyl Tert Butyl Ether (MTBE), or Power-Robbing Ethyl Alcohol, which has about one/fourth the energy of Gasoline and, that the Black Particulates (soot) that exhausts from Diesel engines are all consumed by oxidation to Carbon Dioxide as are all carbon substances.

0015. The importance of Nitrous Oxide (N₂O) cannot be minimized. My invention with the present improvements, does provide a USEFUL QUANTITY of Nitrous, which is wholly dependent upon a Very Large Volume of Ozone and is SELF-Controlling by virtue of the engine's designed in air intake. In WWII, German engineers installed tanks of Nitrous gas in the ME 109 fighter planes, primarily to maintain sea-level power at high altitudes to 45,000 feet. The Nitrous supplied the Oxygen that the super-charger was unable to provide. To repeat, the explosion of Nitrous not only provides power, but it decomposes to Oxygen and Nitrogen.

0016. In the prior art, ozone production was carefully and imperfectly controlled by the use of tachometers, valves gages, instruments, etcetera, to LIMIT the amount of ozone produced, on constantly varying conditions of load, speed, exhaust and so forth. U.S. Pat. No. 6,463,917 and the present improvements produce Ozone and Nitrous in USEFUL quantities. There is no need for any devices to control the flow. The engine uses ALL that is produced. It is the high volume of Ozone produced that makes it possible to obtain EFFECTIVE quantities of Nitrous. It is not small, incidental volumes of Nitrous, to be avoided by using “pure oxygen” instead of air, as prescribed in McAllister, U.S. Pat. No. 4,519,357, or as in Gibboney, U.S. Pat. No. 5,487,874, where “Nitrous oxide is an unacceptable additive in day-to-day driving.” Also, in Miller, U.S. Pat. No. 5,692,481, where “the apparatus does not produce oxides of nitrogen.” (Which would include N₂O).

0017. It is obvious that the very low incidence of Nitrogen Oxides (NOₓ) in the exhaust of the test engine herein, is caused by the formation of USEFUL Nitrous, because, when nitrous explodes in the combustion chambers of an engine, the resulting products are Nitrogen molecules (N₂) which do not register as an oxide of nitrogen; and Oxygen (O₂) which registers ZERO, and does not appear in the exhaust because it exits in the form of Carbon Dioxide (CO₂).

0018. Another improvement is to do away with the posts supporting the electrodes, placing said electrodes in direct contact with the air intake tube and held in place with non-metal screws that attach the high voltage wire of the transformer to the positive electrode, and a ground wire to the electrode directly opposite. A short dielectric tube is treated in the same way, and may be attached to the intake tube, as an extension for convenient installation.

0019. According to the handbook of Chemistry and Physics, Dielectrics, when heated, increase the resistance to the flow of electrons. Basically a dielectric is an insulator. However, no insulator is perfect, therefore, the flow of electrons will pass through such insulators, such as the plastic tube that holds the two electrodes. Intake air should be kept as cool as possible so that the electrons generated will more easily pass through the dielectric. Said dielectric is necessary to spread the charge over the total area of the electrodes. In just one ampere of current, six billion electrons per second, will flow.

0020. Since electricity and magnetism are closely related, in particular, the manner in which a magnetic field controls the electron flow in a television cathode ray tube, an improvement added herein is the use of the grounded negative electrode made of steel, to which a powerful neodymium magnet is attached, effectively causing a larger shower of electrons to pass through the ambient air. When the oxygen molecules (O₂) are struck by an electron, the molecule splits into two oxygen ATOMS (O) and (O). Each atom is missing a paired valence bond, leaving each atom with a single valence bond that makes the atoms highly active radicals that will form Ozone (O₃) upon contact with other oxygen molecules, as well as, form Nitrous Oxide (N₂O) upon contact with ambient Nitrogen molecules (N₂).

0021. Employing these improvements as set forth, herewith, the test engine increased fuel mileage by 33 percent.

In support of many of the facts presented, refer to “General Chemistry and Qualitative Analysis”, Library of Congress Catalog Card Number: 91-050628.

[image]

### BRIEF SUMMARY OF THE INVENTION

0022. While my invention, U.S. Pat. No. 6,463,917 has proven successful, there is room for several improvements. Instead of the electrodes being supported by four posts, they are attached to the air intake tube directly by means of non-metallic screws, penetrating electrodes and the non-metallic intake tube. Said electrodes may be flat plates or curved to fit said intake tube. Said intake tube has dielectric properties. Dielectrics are classified as electrical insulators. Since it is a fact that no insulator is perfect, electrons are capable of passing through them. Dielectrics are required in order to spread the electrical charge over the total area of the electrodes so that the maximum amount of air can be affected.

0023. It is a fact that in one ampere of electrical current, six billion electrons per second are flowing. It is this flow that passes through the ambient air in the intake tube that creates Ozone and Nitrous Oxide.

0024. An improvement is the use of a super capacitor that charges and discharges at extremely high velocity, thereby quickly saturating the primary coil of the transformer with high energy pulses and making said transformer most effective.

0025. A further excellent improvement involves making the negative, grounded electrode out of steel and attaching a very powerful neodymium alloy magnet to said electrode to have an increased effect on, literally a shower of electrons. All of the foregoing improvements have resulted in greatly increased power and a 33% increase in fuel mileage.

0026. An additional section of dielectric tubing, with all of the foregoing improvements added, may be attached at the entrance to the intake tube for convenience instead of placing them in a difficult to reach place on said intake tube.

### BRIEF DESCRIPTION OF THE SEVERAL VIEWS OF THE DRAWINGS

FIG. 1 is the drawing found in U.S. Pat. No. 6,463,917 that shows the use of flat plate metal electrodes supported by non-conductive posts, holding said electrodes in contact with the air intake tube. This method of construction is changed as further shown.

FIG. 2 is a side view of the positive electrode as attached to the dielectric tube that acts on ambient air, and said electrode is curved to fit said dielectric tube. Said electrodes may be flat, including the negative electrode directly opposite.

FIG. 2A is an end view of said dielectric tube, showing said electrodes in contact with said dielectric tube and held in place with non-conductive screws, and said negative electrode grounded.

FIG. 3 shows the method of wiring a 12 volt battery power source, to the high voltage transformer, then to the positive electrode, with a capacitor soldered to said battery wire as shown.

### DETAILED DESCRIPTION OF THE INVENTION

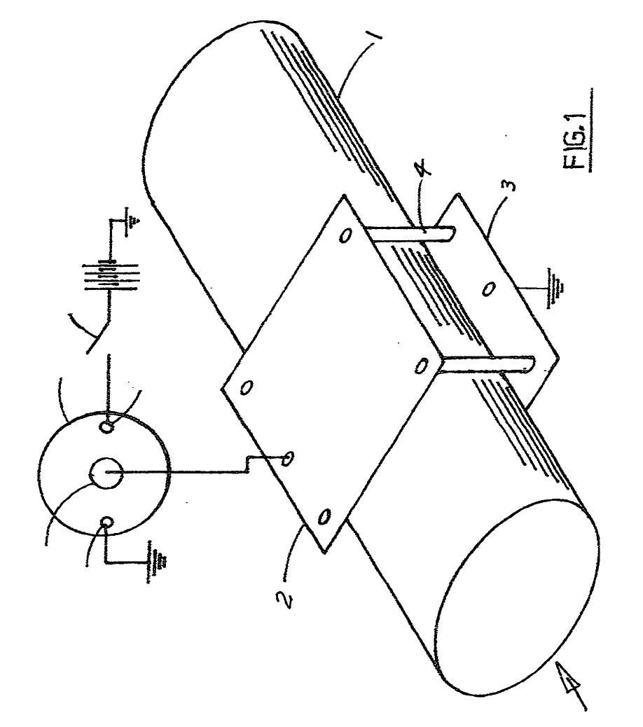

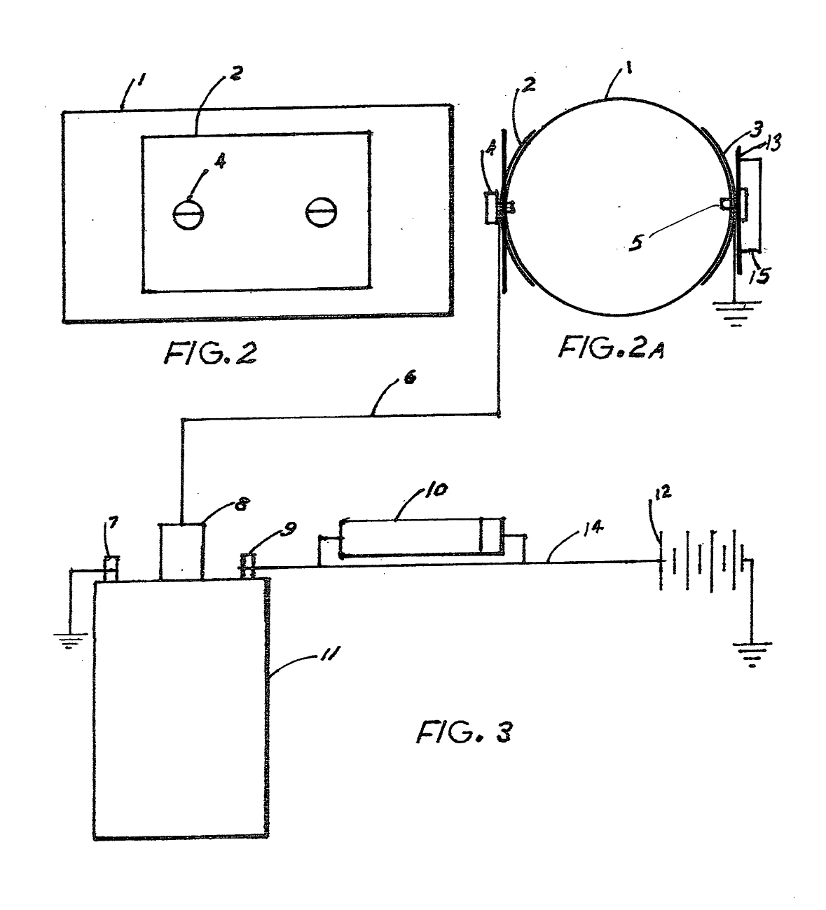

0027. Further research indicated that improvements could be made to my U.S. Pat. No. 6,463,917. Accordingly a manufacturing improvement was made by eliminating the four supporting posts seen in FIG. 1 and placing the electrodes 2 and 3, in contact with the air intake tube 1, in FIG. 1 or the additional tube 1, as seen in FIG. 2 and 24 and held in place with non-metallic screws 4 and 5. A powerful neodymium alloy magnet 15, is attached magnetically to the steel negative electrode 13, which is a flat electrode that is grounded and used in place of the curved electrode 3. Said additional tube must have dielectric properties.

0028. Electrical wiring is done as in the original patent. A wire 14, connects the battery source of power 12, to the positive post 9, of the transformer 11, and a suitable capacitor 10, is soldered to said wire 14, so that battery current will enter said capacitor at its positive end first. Negative post 7, is gounded and high voltage post 8, delivers its charge by wire 6 to positive electrode 2. A flat plate electrode may be used instead of curved electrode 2.

0029. The additional tube is attached to the existing air intake tube of the engine. Said additional tube converts ambient air to ozone and Nitrous Oxide before being drawn into the engine. Said additional tube is used when it is too difficult to apply the electrodes to the main part of the intake tube.

I claim:

1. Apparatus for improving U.S. Pat. No. 6,463,917 by electronically forming and injecting large and useful quantities of Ozone (O₃), and Nitrous oxide (N₂O), derived from Oxygen molecules (O₂), and Nitrogen molecules (N₂), in ambient air, into internal combustion engines, and removing noxious nitrogen oxides from their exhausts, comprising:
inlet means for receiving an air supply, consisting of non-metallic tubing having dielectric properties with attached metal electrodes sandwiching said tubing that send electrons to split the oxygen molecule into two highly active radicals.

2. The apparatus as defined in claim 1, wherein said metal electrodes consist of various materials and having a steel negative electrode with attached magnet.

3. The apparatus as defined in claim 2, wherein a shower of electrons is caused to pass through incoming ambient air where said electrons are increased in volume and energy by magnets.

4. The apparatus as defined in claim 2, wherein a super capacitor is attached to, and parallel to the wire that connects battery power to a transformer then to the electrodes.

5. The apparatus as defined in claim 4, wherein said capacitor delivers high speed pulses that rapidly load the primary winding of said transformer to effectively deliver electrons in high volume.

6. The apparatus as defined in claim 1, wherein the conversion to Ozone and Nitrous Oxide is continuous and self-controlling.
